(19) United States
(12) Patent Application Publication
(10) Pub. No.: US 2003/0107468 A1
(43) Pub. Date: Jun. 12, 2003

(54) Entry security device

(76) Inventor: Linda Din, Taichung Hsien (TW)

Correspondence Address: Rabin & Berdo, P.C., Suite 500, 1101 14th Street, Washington, DC, 20005, US

(21) Appl. No.: 10/254,797

(22) Filed: Sep. 26, 2002

(30) Foreign Application Priority Data
Dec. 7, 2001 (CN) 01 2 75745.4

(51) Int. Cl. H04Q 1/00

(52) U.S. Cl. 340/5.7

(57) ABSTRACT

An entry security device has a validation device adapted to control an electronic door lock and at least one contactless keycard. The contactless keycard and the validation device have the same identification codes, so that the contactless keycard sends the identification code to the validation device to check for a match with the identification codes in the validation device. A new identification code is generated by the validation device when a match is found and then is inductively sent to the contactless keycard to replace the previous identification code.

### BACKGROUND OF THE INVENTION

1. Field of the Invention

The present invention relates to an entry security device, and more particularly to an entry security device with at least one contactless keycard and a validation device. Each contactless keycard has a unique identification code. The validation device senses and checks the identification code of the contactless keycard. The identification code in the contactless keycard is changed each sense with the validation device. Therefore the entry security device is an active and dynamic device.

2. Description of Related Art

In the past, an entry security device only has a complex mechanical lock to prevent unauthorized people from entering protected premises. When magnetic cards were developed, the entry device combined an electronic card reader with the lock to control the operation of the lock. The cardholder only had to insert the magnetic card into the card reader, and the card reader could read the identification code from magnetic card and check the identification of the cardholder. However, the magnetic strip on the magnetic card is either inadvertently erased or loses its ability to store and hold the identification code after extended use.

Recently, an inductive keycard was developed to introduce a new data reading technique for cards. The inductive keycard does not have to be inserted into the card reader, and the data reader can still read the inductive keycard identification code. Therefore the inductive keycard is more convenient to use than the magnetic card. However, both types of keycards have fixed identification codes in the card memory device and do not have any other functions. Memory available on the magnetic card is only 128K bits. Because the identification code is fixed and the memory is easily accessible, the identification code is easily stolen and written onto other card the same as the original card.

To overcome the shortcomings, the present invention provides an improved entry security device to mitigate and obviate the aforementioned problems.

### SUMMARY OF THE INVENTION

The main objective of the invention is to provide that an entry security device with a dynamic identification function implemented by a validation device and at least one contactless keycard.

Another objective is to embed a power source and read/write memory in the contactless keycard to actively retrieve, change and storage identification codes.

Another objective is to embed an encoder/decoder in the contactless keycard to adapt the contactless keycard to inductive validation devices with different encoding algorithms.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a validation device in accordance with the present invention;

FIG. 2 is a layout diagram of a power chip in accordance with the present invention; and

FIG. 3 is a layout diagram of a contactless keycard in accordance with the present invention.

### DETAILED DESCRIPTION OF THE PREFERRED EMBODIMENT

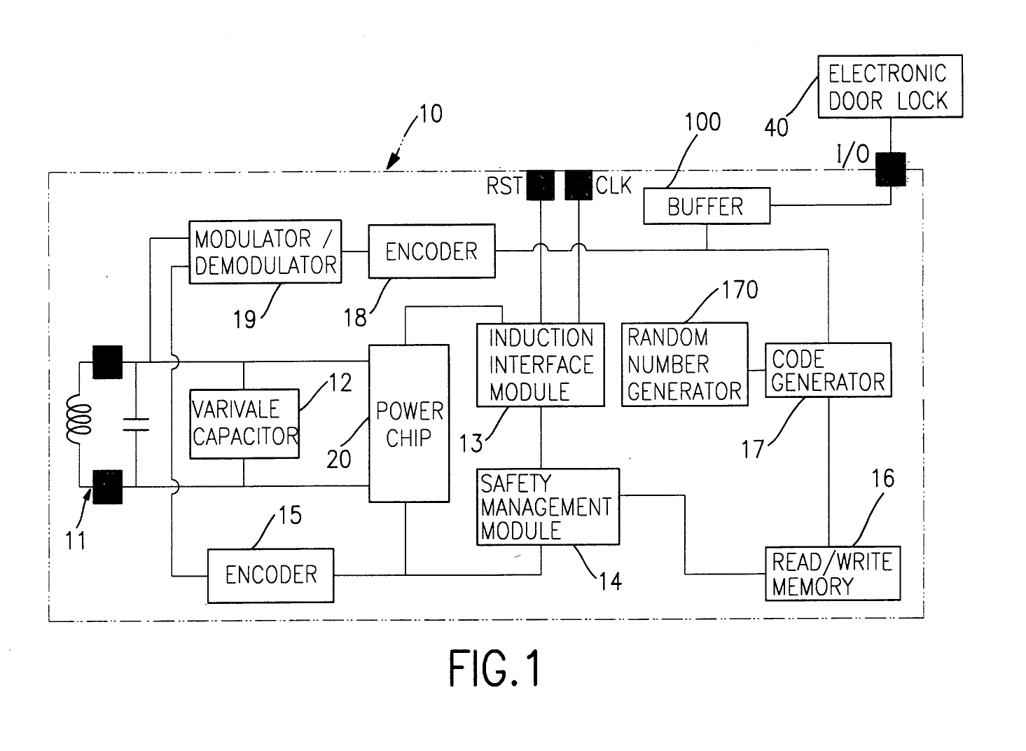

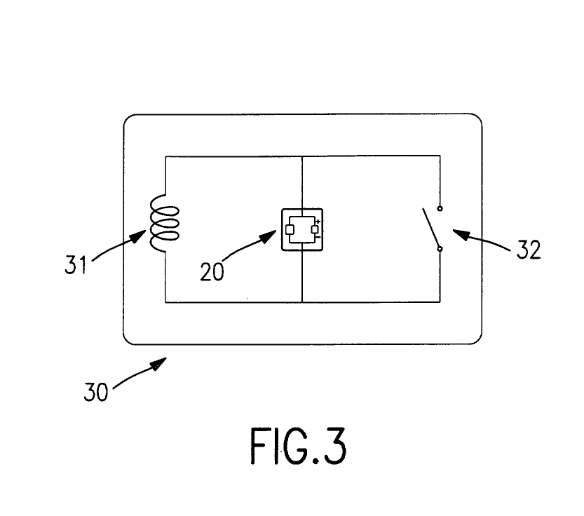

With reference to FIGS. 1 and 3, the entry security device in accordance with the present invention is adapted to control an electronic door lock (40) and has a validation device (10) and at least one contactless keycard (30). The contactless keycard (30) inductively communicates with the validation device (10) that carries out the identification procedure to activate the electronic door lock and open the door.

The validation device (10) comprises an antenna (11), a variable capacitor (12), a modulator/demodulator (19), an encoder (18), a decoder (15), a power chip (20), an induction interface module (13), a safety management module (14), a read/write memory (16), a code generator (17), a random code generator (170) and a buffer (100).

The variable capacitor (12) is connected to the power chip (20) and in parallel with the antenna (11). The antenna (11) is also connected to the modulator/demodulator (19). The modulator/demodulator (19) is connected to the encoder (18) and the decoder (15). The decoder (15) is connected to the power chip (20). The power chip is further connected to a safety management module (14) and two contact terminals RST/CLK through the induction interface module (13). The safety management module (14) is connected to the decoder (15) and the read/write memory (16). The read/write memory (16) is connected to the code generator (17). The encoder (18) is connected to the code generator (17) that is connected to the random number generator (170) that provides data to code generator (17). The code generator (17) controls the electronic door lock (40) through the buffer (100).

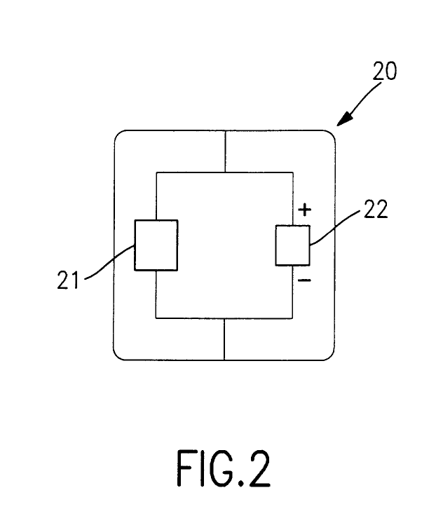

With reference to FIG. 2, the power chip (20) includes a control unit (21) and a flat battery module (22) which is provided a power to the control unit (21). The control unit (21) has arithmetic check and access data etc. functions.

With reference to FIG. 3, the contactless keycard (30) has an antenna (31), a power chip (20) and a pushbutton (32). The power chip (20) also has a control unit (21) and a flat battery module (22). The pushbutton is connected between the control unit (21) and the flat battery module (22). An identification code the same as the one in the validation device (not shown) is stored in the control unit (21) of the power chip (20) (20) of contactless keycard (30). The antenna (31) is connected to the power chip (20). The pushbutton (32) controls whether a loop between the control unit (21) and flat battery module (22) closes or not. Pressing the pushbutton (32) provides power from the flat battery module (22) to the control unit (21). The control unit (21) outputs the identification code and sends it to the validation device (not shown) through the antenna (31) when the pushbutton (32) is pressed.

With reference to FIGS. 1 and 3, the antenna (11) in the validation device (10) inductively receives the identification code from the contactless keycard (30). The identification code is input to the modulator/demodulator (19) and the demodulated signal is converted to digital data by the decoder (15) and then input to the safety management module (14) and the read/write memory (16) to check the identification code from the keycard (30) with the identification codes in the read/write memory (16). When the identification code in the keycard (30) matches an identification code in the validation unit (10), the electronic door lock (40) is opened. Before the electronic door lock opens, the random code generator (170) and the code generator (17) outputs a new identification code to the antenna (11) through the encoder (18) and the modulator/demodulator (19). The new identification code is written simultaneously into the read/write memory (16) to replace the old identification code. When the antenna (31) of the contactless keycard (30) inductively receives the new identification code the new identification code replaces the previous identification code in power chip (20) of the contactless keycard (30). The identification code in the contactless keycard (30) is changed each time the keycard (30) accesses the validation device (10) so that using an identification code copied or stolen from the contactless keycard (30) is very different. In addition, the contactless keycard (30) has its own power from the flat battery module (22) to store the identification code with long length of bits. Each identification code is about 1 Gbits long to make unauthorized decoding of the identification code more difficult.

Based on the above description, when the electronic door lock with the present invention checks every contactless keycard each entry, and a new identification code from the validation device replaces the identification code on the keycard during each use. Therefore the electronic door lock is an active security device having a useful and effective ID checking function.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An entry security device, comprising:
a validation device having at least one identification code adapted to control an electronic door lock, wherein the validation device comprises
an antenna;
a power chip connected to the antenna, wherein the power chip has a control unit and a flat battery module connected to the control unit;
an encoder connected to the antenna;
an decoder connected to the power chip;
a read/write memory connected to the decoder; and
a code generator connected between the read/write memory and the encoder to open or close the electronic door lock; and
at least one contactless keycard having at least one identification code inductively read by the validation device to control the electronic door lock operation based on a match of identification codes in the contactless keycard and the validation device.

2. The entry security device as claimed in claim 1, wherein a variable capacitor is connected between the antenna and the power chip.

3. The entry security device as claimed in claim 1, wherein the power chip is further connected to an induction interface module and a safety module that is connected to the read/write memory.

4. The entry security device as claimed in claim 1, the validation device further comprises a random number generator connected to the code generator.

5. The entry security device as claimed in claim 1, the validation device further comprises a modulator/demodulator connected among the encoder, the decoder and the antenna.

6. The entry security device as claimed in claim 1, where the code generator controls the electronic door lock through a buffer.

7. The entry security device as claimed in claim 1, wherein each contactless keycard comprises:
an antenna;
a power chip connected to the antenna, wherein the controller has a control unit and a flat battery module; and
a pushbutton connected in series to the control unit and the flat battery module.
